(19) United States
(12) Patent Application Publication
(10) Pub. No.: US 2010/0119059 A1
(43) Pub. Date: May 13, 2010

(54) Integrated Circuit Device and Data Transmission System

(76) Inventors: Kazuo KOJIMA, Kanagawa (JP); Kaoru Yanamoto, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/498,788

(22) Filed: Jul. 7, 2009

(30) Foreign Application Priority Data
Nov. 7, 2008 (JP) P2008-181879

(51) Int. Cl. H04L 9/00

(52) U.S. Cl. 380/42

(57) ABSTRACT

An integrated circuit device includes: a reception control unit that receives data from an information processing terminal over a network; a main control unit having a route selection determining unit that controls selection of data to be transmitted to a subsequent system based on information whether data received by the reception control unit is encrypted; a decrypting unit that decrypts the encrypted data outputted from the main control unit; and a route selector that selects whether to acquire undecrypted data outputted from the main control unit or to acquire decrypted data outputted from the decrypting unit based on control by the route selection determining unit.

### BACKGROUND OF THE INVENTION

1. Field of the Invention

The present invention relates to an integrated circuit device that applies predetermined signal processing to data received over a network, and a data transmission system.

2. Description of the Related Art

In acquiring a multimedia file such as a video or audio file over a network such as the Internet, a data transmission method called streaming is widely used in which data is reproduced while the data is being received.

Generally, a user downloads a file and then opens and reproduces the file, and when the user reproduces a large-sized file such as moving images, it takes a very long time to reproduce the file. Then, application software according to streaming is used, in which a file is reproduced while the file is being downloaded at the same time, whereby waiting time can be greatly shortened. In file reproduction according to streaming, multimedia, for example, can be reproduced in real time even though a slow communication line is used.

In transmitting data acquired by streaming through a network such as a LAN (Local Area Network) at home, for example, a copyrighted content is encrypted and transferred in accordance with DTCP/IP (Digital Transmission Content Protection over Internet Protocol), whereby the content can be reproduced. In addition, on the other hand, a non-copyrighted content is not encrypted and transferred in accordance with TCP/IP (Transmission Control Protocol/Internet Protocol).

In an integrated circuit device that conducts such data transmission, a CPU (Central Processing Unit) as a main control unit reads a port number in a TCP header out of an IP frame inputted through an Ethernet (trademark) controller, and the CPU determines whether TCP data is encrypted data or unencrypted data. Here, in either streaming data and Web data, data may be encrypted or not encrypted.

An example of related art includes JP-A-2006-211227 (Patent Document 1).

### SUMMARY OF THE INVENTION

For encrypted data, the CPU removes its IP header and TCP header, passes only the encrypted TCP data to a decrypting unit (decryption block), receives the decrypted TCP data from the decrypting unit, and then inputs the decrypted TCP data to a block in a subsequent system. For the block in the subsequent system, an MPEG (Moving Picture Experts Group) decoder or the like is named when data is streaming data, and a CPU or the like is named when data is Web data.

Here, streaming data has a large data volume, and in such processing, CPU resources are soon consumed. Particularly, a CPU for use in an embedded device has limits to streaming bands.

Thus, it is desirable to reduce the processing loads of a CPU for signal processing in transmitting streaming data acquired through a network.

According to an embodiment of the invention, there is provided an integrated circuit device including: a reception control unit that receives data from an information processing terminal over a network; a main control unit having a route selection determining unit that controls selection of data to be transmitted to a subsequent system based on information whether data received by the reception control unit is encrypted; a decrypting unit that decrypts the encrypted data outputted from the main control unit; and a route selector that selects whether to acquire undecrypted data outputted from the main control unit or to acquire decrypted data outputted from the decrypting unit based on control by the route selection determining unit.

According to another embodiment of the invention, there is provided an integrated circuit device including: a main control unit having a reception control unit that receives data from an information processing terminal over a network; a route selection determining unit that controls selection of data to be transmitted to a subsequent system based on information whether data received by the reception control unit is encrypted; a decrypting unit that decrypts the encrypted data outputted from the main control unit; and a route selector that selects whether to acquire undecrypted data outputted from the main control unit or to acquire decrypted data outputted from the decrypting unit based on control by the route selection determining unit.

According to still another embodiment of the invention, there is provided a data transmission system including: an information processing terminal; and an integrated circuit connected to the information processing terminal over a network, wherein the integrated circuit includes, a reception control unit that receives data from an information processing terminal over a network; a main control unit having a route selection determining unit that controls selection of data to be transmitted to a subsequent system based on information whether data received by the reception control unit is encrypted; a decrypting unit that decrypts the encrypted data outputted from the main control unit; and a route selector that selects whether to acquire undecrypted data outputted from the main control unit or to acquire decrypted data outputted from the decrypting unit based on control by the route selection determining unit.

According to still another embodiment of the invention, there is provided a data transmission system including: an information processing terminal; and an integrated circuit connected to the information processing terminal over a network, wherein the integrated circuit includes, a main control unit having a reception control unit that receives data from an information processing terminal over a network; a route selection determining unit that controls selection of data to be transmitted to a subsequent system based on information whether data received by the reception control unit is encrypted; a decrypting unit that decrypts the encrypted data outputted from the main control unit; and a route selector that selects whether to acquire undecrypted data outputted from the main control unit or to acquire decrypted data outputted from the decrypting unit based on control by the route selection determining unit.

According to the embodiments of the invention, the processing loads of a CPU as the main control unit can be reduced in signal processing in transmitting streaming data acquired through a network.

### BRIEF DESCRIPTION OF THE DRAWINGS

FIG. 1 is a diagram depicting the configuration of a data transmission system of a first embodiment to which the invention is adapted;

FIG. 2A is a diagram depicting the structure of an IP header, and FIG. 2B is a diagram depicting the structure of a TCP header;

FIG. 3 is a diagram depicting the configuration of a data transmission system of a second embodiment to which the invention is adapted; and

FIG. 4 is a diagram depicting the configuration of a data transmission system before.

### DESCRIPTION OF THE PREFERRED EMBODIMENTS

Hereinafter, specific embodiments to which the invention is adapted will be described in detail with reference to the drawings.

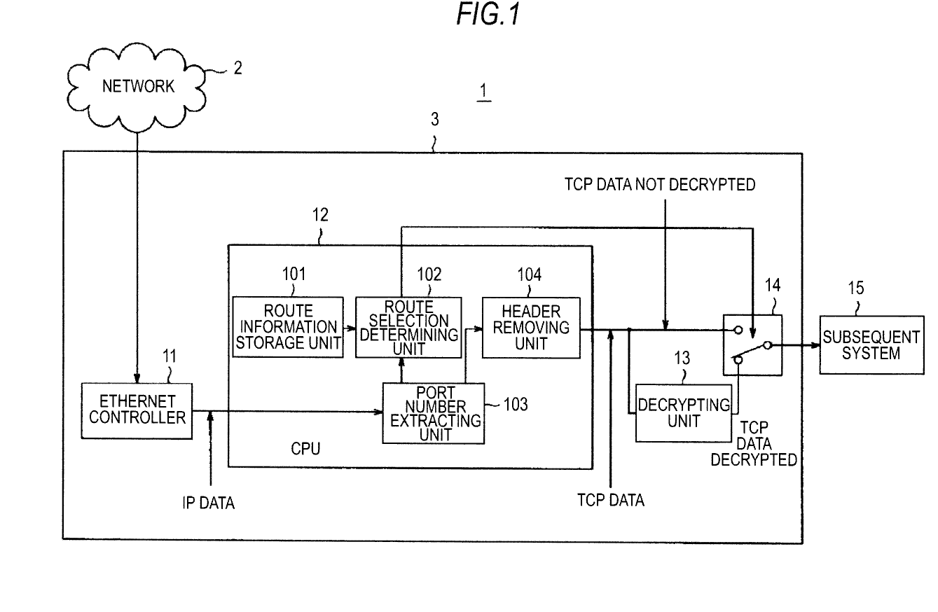

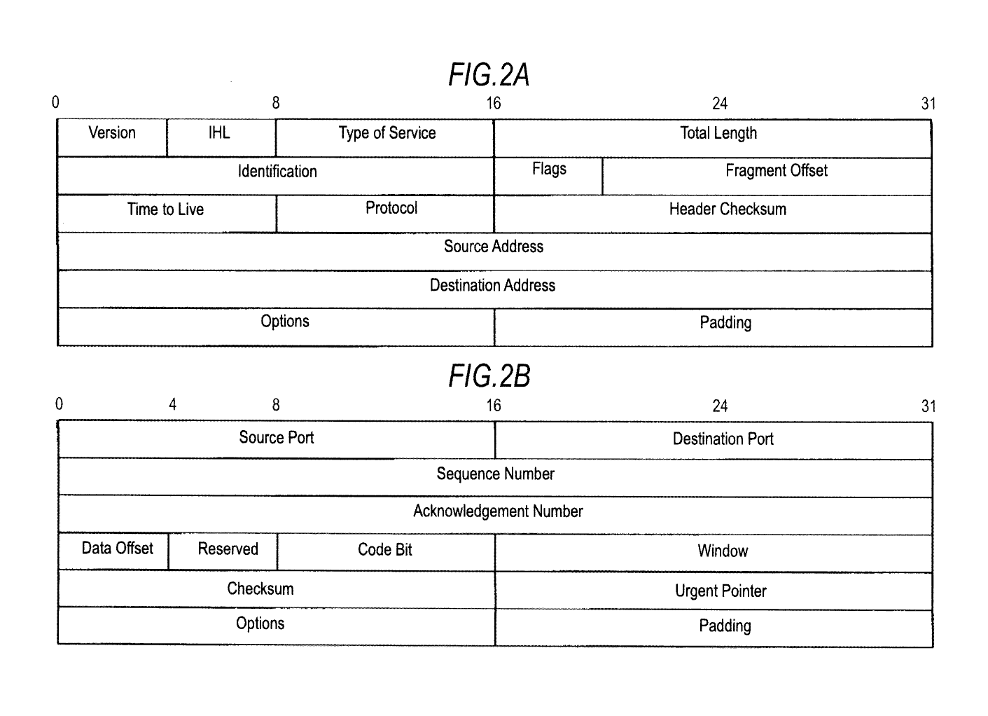

FIG. 1 is a diagram depicting the configuration of a data transmission system 1 of a first embodiment to which the invention is adapted. To a network 2, an integrated circuit device 3 and a server (not shown) as an information processing terminal are connected. The integrated circuit device 3 and the server send and receive data (IP packets) each attached with a TCP header having a structure shown in FIG. 2A and an IP header having a structure shown in FIG. 2B by streaming in accordance with TCP/IP.

As shown in FIG. 2A, in the IP header, a version field is a first four-bit field of the IP header, indicating the version of the IP protocol. An Internet header length field is a four-bit field in the IP header, indicating the length of the IP header itself in a unit of 32 bits. A type of service field is an eight-bit field in the IP header, indicating the characteristic of a service requested from the IP packet. A rooter transfers packets with reference to these fields so as to implement requested quality.

A packet length field indicates the total length of the packet including the IP header and IP data by 16-bits. An identification field is a 16-bit field in the IP header, in which an ID number is set, the ID number being assigned by a server that is a sender host for identifying individual IP packets. A flags field is a three-bit field in the IP header. The first bit is not used, and the second bit is used to specify whether or not to permit fragmentation. The third bit indicates whether a fragment is the middle one or the last one of an original IP packet when the IP packet is fragmented.

A fragment offset field is a 13-bit field in the IP header, indicating the ordinal position of a fragment when the IP packet is fragmented. A time to live field is an eight-bit field in the IP header, indicating the maximum lifetime during which an IP packet is allowed to exist on the Internet.

A protocol field is an eight-bit field in the IP header, indicating the type of the protocol used for a higher layer of an encapsulated IP packet.

A header checksum field is a 16-bit field in the IP header, which checks only the header by CRC (Cyclic Redundancy Checking). A source IP address field indicates the IP address of a sender. A destination IP address field indicates the IP address of a receiver.

An options field directs a special process to be conducted in transmitting an IP packet. A padding field adjusts the length of the header to be an integral multiple of 32 bits when an option is used.

In addition, as shown in FIG. 2B, in the TCP header, in a source port number field, a port number of an application used by the sender is set. In a destination port number field, a port number of an application used by the receiver is set.

In a sequence number field, a number is set, the number indicating from which byte data is sent from the sender. In an acknowledgement number field, a number is set, the number indicating which byte of data the receiver is to request next time. A data offset field indicates the length of the TCP header by four bytes. A reserved field is a field provided for future expansion, currently setting zero to all.

In a code bit field, flags such as URG (Urgent Flag) and ACK (Acknowledgement Flag) are set. A window size field notifies the receive window size that is the size of data receivable without acknowledgement. A checksum field detects error throughout the segment formed of the TCP header and a data portion. An urgent pointer field indicates from which to which data is urgent data when an URG flag is on.

As shown in FIG. 1, the integrated circuit device 3 has an ethernet controller 11 as a reception control unit, a CPU 12 as a main control unit, a decrypting unit 13, and a route selector 14.

The ethernet controller 11 supplies ethernet frames that are IP packets received over the network 2 to port number extracting part 103 in the CPU 12.

The CPU 12 has a route information storage unit 101, a route selection determining unit 102, the port number extracting unit 103, and a header removing unit 104.

The ethernet frame (IP data) supplied from the ethernet controller 11 is fed to the header removing unit 104 through the port number extracting unit 103.

The route information storage unit 101 is formed of a part of the area of a cache memory (not shown) provided in the CPU 12, which stores route information for each port number.

In the integrated circuit device 3, the route information for each port number is acquired as described below. The CPU 12 sets a source port number in the TCP header of TCP data, and makes access to the server over the network 2. In response to a request for the source port number from the integrated circuit device 3, the server sends streaming data as the destination port number to the integrated circuit device 3.

At this time, when the server requests the integrated circuit device 3 to make authentication, the integrated circuit device 3 receives encrypted data from the server over the network 2. On the other hand, when the server does not request the integrated circuit device 3 to make authentication, the integrated circuit device 3 receives unencrypted data over the network 2. Here, for authentication methods, for example, various methods can be used such as symmetric keys and cryptographic keys. The CPU 12 stores data information at this time in the route information storage unit 101 as route information for each port number. In other words, in the route information storage unit 101, such information is stored as corresponding to the port number who sends data (communication counterpart) and whether data is encrypted (the server requests authentication) or not encrypted (the server does not request authentication).

The port number extracting unit 103 extracts the port number from the TCP header of the ethernet frame supplied from the ethernet controller 11, and feeds it to the route selection determining unit 102 as well as feeds IP data to the header removing unit 104.

The route selection determining unit 102 reads route information for each port number stored in the route information storage unit 101, and controls the route selector 14 based on the route information for each port number. In other words, when the route information for each port number read out of the route information storage unit 101 is information indicating that data is encrypted, the route selection determining unit 102 supplies a control signal to control the route selector 14 to select decrypted data from the decrypting unit 13. In addition, when the route information for each port number read out of the route information storage unit 101 is information indicating that data is not encrypted, the route selection determining unit 102 supplies a control signal to control the route selector 14 to select undecrypted data fed from the header removing unit 104.

The header removing unit 104 removes the IP header and the TCP header from IP data to be TCP data. Then, the header removing unit 104 supplies encrypted TCP data to the decrypting unit 13. Alternatively, the header removing unit 104 supplies TCP data, which is not encrypted and thus decryption is unnecessary, to the route selector 14.

The decrypting unit 13 performs a process of decrypting encrypted TCP data outputted and supplied from the header removing unit 104 in the CPU 12.

Based on control by the route selection determining unit 102 for selecting either decrypted TCP data or undecrypted TCP data, the route selector 14 selects a route by controlling a switch, and sends decrypted TCP data or undecrypted TCP data to a subsequent system.

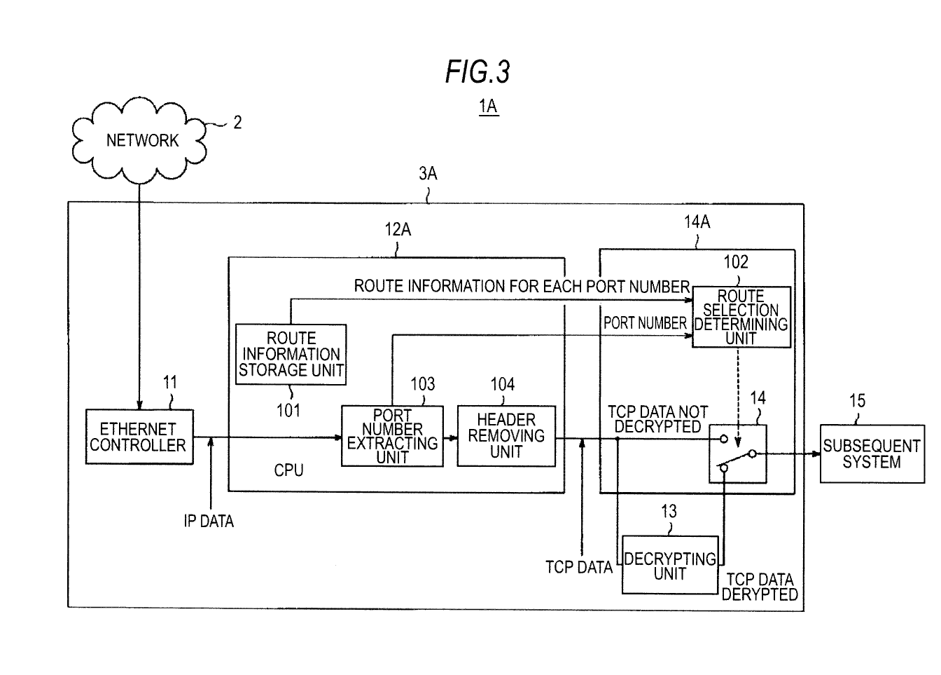

In addition, FIG. 3 is a diagram depicting the configuration of a data transmission system 1A of a second embodiment to which the invention is adapted. In FIG. 3, the configurations similar to those in FIG. 1 are designated the same numerals and signs to omit the descriptions.

An integrated circuit device 3A is configured to have a route selection determining unit 102 and a route selector 14, described above, in the same block (this block is a route selection processing unit 14A).

An ethernet frame received from a network 2 is passed through an ethernet controller 11 to a port number extracting unit 103 in a CPU 12A, and then supplied to a header removing unit 104. Then, the CPU 12A outputs TCP data, from which an IP header and a TCP header are removed. When TCP data is encrypted, the TCP data is inputted to a decrypting unit 13, whereas when TCP data is not encrypted, the TCP data is inputted to the route selector 14.

In addition, the CPU 12A reads route information for each port number out of a route information storage unit 101, and supplies the route information to the route selection determining unit 102. When the route information for each port number supplied from the CPU 12A is information indicating that TCP data is encrypted, the route selection determining unit 102 feeds a control signal to control the route selector 14 to select decrypted data from the decrypting unit 13. In addition, when the route information for each port number supplied from the CPU 12A is information indicating that TCP data is not encrypted, the route selection determining unit 102 feeds a control signal to control the route selector 14 to select undecrypted data supplied from the header removing unit 104.

In the existing integrated circuit device, the CPU is configured to have the route selector described above.

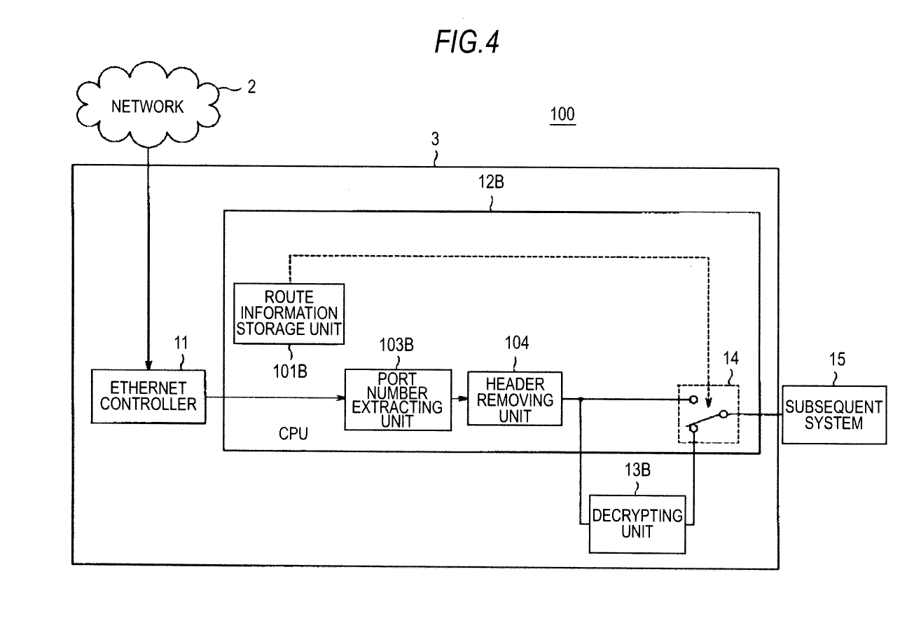

FIG. 4 is a diagram depicting an exemplary configuration of an existing data transmission system. Also in FIG. 4, the configurations similar to those in FIG. 1 are designated the same numerals and signs to omit the descriptions.

In an integrated circuit device 100 provided in the existing data transmission system, an ethernet controller 11 receives an IP frame inputted from a server over a network 2. A CPU 12B reads a port number in a TCP header out of the IP frame, determines whether TCP data is encrypted, and controls the switching operations of a route selector 14 based on route select information for each port number stored in a route information storage unit 101B. In this case, the number of times of data inputs and outputs to the CPU 12B through a bus line is three times.

On the other hand, in the integrated circuit device of the embodiments having the configurations described above, because the route selector is provided outside the CPU, the number of times of data inputs and outputs to the CPU through the bus line can be reduced to two times in signal processing in transmitting streaming data received over the network to the subsequent system. Thus, the band used by the CPU bus (not shown) can be cut to about 67% of the band previously used, the data volume passing through a newly available bus band can be increased up to 1.5 times, and resources newly available because of CPU band control can be assigned to other processes.

In addition, the embodiments of the invention are not limited only to the embodiments described above, and they can be variously modified within the scope of the teachings of the invention.

The present application contains subject matter related to that disclosed in Japanese Priority Patent Application JP filed in Japan Patent Office on Jul. 11, 2008, the entire contents of which is hereby incorporated by reference.

What is claimed is:

1. An integrated circuit device comprising:
a reception control unit that receives data from an information processing terminal over a network;
a main control unit having a route selection determining unit that controls selection of data to be transmitted to a subsequent system based on information whether data received by the reception control unit is encrypted;
a decrypting unit that decrypts the encrypted data outputted from the main control unit; and
a route selector that selects whether to acquire undecrypted data outputted from the main control unit or to acquire decrypted data outputted from the decrypting unit based on control by the route selection determining unit.

2. The integrated circuit device according to claim 1, wherein data received over the network is streaming data.

3. The integrated circuit device according to claim 1, wherein the main control unit further has a storage unit that stores information as route select information for each of destination port numbers extracted from data received by the reception control unit over the network, the information indicating whether the data is encrypted.

4. An integrated circuit device comprising:
a main control unit having a reception control unit that receives data from an information processing terminal over a network;
a route selection determining unit that controls selection of data to be transmitted to a subsequent system based on information whether data received by the reception control unit is encrypted;
a decrypting unit that decrypts the encrypted data outputted from the main control unit; and
a route selector that selects whether to acquire undecrypted data outputted from the main control unit or to acquire decrypted data outputted from the decrypting unit based on control by the route selection determining unit.

5. The integrated circuit device according to claim 4, wherein data received over the network is streaming data.

6. The integrated circuit device according to claim 4, wherein the main control unit further has a storage unit that stores information as route select information for each of destination port numbers extracted from data received by the reception control unit over the network, the information indicating whether the data is encrypted.

7. A data transmission system comprising:
an information processing terminal; and
an integrated circuit connected to the information processing terminal over a network,
wherein the integrated circuit includes,
a reception control unit that receives data from an information processing terminal over a network;
a main control unit having a route selection determining unit that controls selection of data to be transmitted to a subsequent system based on information whether data received by the reception control unit is encrypted;
a decrypting unit that decrypts the encrypted data outputted from the main control unit; and
a route selector that selects whether to acquire undecrypted data outputted from the main control unit or to acquire decrypted data outputted from the decrypting unit based on control by the route selection determining unit.

8. A data transmission system comprising:
an information processing terminal; and
an integrated circuit connected to the information processing terminal over a network,
wherein the integrated circuit includes,
a main control unit having a reception control unit that receives data from an information processing terminal over a network;
a route selection determining unit that controls selection of data to be transmitted to a subsequent system based on information whether data received by the reception control unit is encrypted;
a decrypting unit that decrypts the encrypted data outputted from the main control unit; and
a route selector that selects whether to acquire undecrypted data outputted from the main control unit or to acquire decrypted data outputted from the decrypting unit based on control by the route selection determining unit.
